(19) United States
(12) Patent Application Publication
(10) Pub. No.: US 2004/0158765 A1
(43) Pub. Date: Aug. 12, 2004

(54) Device and method for controlling data traffic in a tcp/ip data transmission network

(76) Inventor: Joachim Charzinski, Oberschleissheim (DE)

Correspondence Address: MORRISON & FOERSTER LLP, 1650 TYSONS BOULEVARD, SUITE 300, MCLEAN, VA, 22102, US

(21) Appl. No.: 10/432,367

(22) PCT Filed: Nov. 15, 2001
(86) PCT No.: PCT/DE01/04292

(30) Foreign Application Priority Data
Nov. 22, 2000 (DE) 100 57 790.3

(51) Int. Cl. H02H 3/05

(52) U.S. Cl. 714/4

(57) ABSTRACT

The invention relates to a device for controlling data traffic (7) in TCP/IP data transmission networks. Said device comprises a transmitter (6) that transmits data to a second terminal node (3), a detection device (8) for detecting an overload situation of the device for controlling data traffic (7), and a signaling device (9) for generating signal messages that announce the overload situation to the first terminal node (2). The invention further relates to a method for controlling data traffic in TCP/IP data transmission networks.

The present invention relates to an apparatus and a method for traffic control for data traffic in TCP/IP data transmission networks.

In order to provide an assured quality of service (QOS) in an IP-based data transmission network, it is first of all necessary to define a number of parameters for data transmission between a subscriber and the data transmission network; in the simplest case, the maximum data transmission speed is defined.

However, the TCP transmission protocol, which is normally used for data transmission via IP-based data transmission networks (for example for transmitting files and Internet data transmission), does not offer any simple possible way to match the maximum data transmission rate to the parameters of the transmission path, or to the transmission speed for the maximum amount of data which may be transmitted by the transmitter (end node).

The data transmission rate is limited only by the following factors:

Firstly, the data transmission rate is limited by the data transmission rate that is available in the data transmission network or on the transmission path. If the data speed through the end node is too high, data packets will be rejected. In this case, TCP provides a fair distribution of the available transmission speed between the various end nodes on the basis of the packet loss rate.

Furthermore, the maximum transmission speed is governed by the transmission speed which the receiving end node (second end node) can process. This is indicated in a field in the TCP data header (TCP header) of the data packets which are sent back, which field indicates a maximum packet size.

The maximum transmission speed is also governed by the transmission speed which the transmitting end node can produce, for example governed by the processing speed and/or by the access time to a hard disk.

However, these methods have the disadvantage that the transmission speed cannot be matched to the characteristics of the transmission path or to a traffic contract between a user and a network operator. The transmission speed is limited only by data packets being rejected when the transmission network is overloaded.

In the prior art, the problem of matching the transmission speed to a traffic contract is solved by rejecting data packets when a specific transmission speed is exceeded for a predetermined time.

When data packets are rejected, then no acknowledgement is produced by the end node for which the data packets are intended (second end node); in the absence of an acknowledgement, data packets which have been rejected are retransmitted by the first end node, and the transmission speed is reduced. This mechanism is used in TCP/IP data transmission networks, matched to variable packet sizes, for example in the form of the so-called “leaky bucket” algorithm, which is known from ATM data transmission.

The document [1] “TCP-Rate Control”, Technical Report, Rensselaer Polytechnic Institute, S. Karandikar et al., describes a method in which the data transmission rate is influenced by manipulating the packet size and the acknowledgement packets. However, this method requires a high level of computation power, for example in order to recalculate the checksum in the TCP packet header.

The document [2] K. Ramakrishnan et al., “A Proposal to add Congestion Notification (ECN) to IP”, Internet RFC 2481, January 1999, proposes a method in which an overload situation is indicated by setting a so-called ECN bit (Explicit Congestion Notify) in the packet header of an IP data packet. However, this method has the disadvantage that only overload situations can be indicated by switching nodes in the data transmission network. No regulation is provided for the transmission speed of a specific end node to a preset value.

The object of the present invention is thus to provide an apparatus for traffic control for data traffic in TCP/IP data transmission networks, and a method which is used in this apparatus for traffic control, which method and apparatus make it possible to match the transmission speed of the data from a transmitter (first end node) to a specific predetermined transmission speed for TCP/IP data transmission, with little complexity. This matching process should in this case involve as little loss of data as possible.

This object is achieved by an apparatus for traffic control for data traffic in TCP/IP data transmission networks as claimed in the attached claim 1, and by a method, which is used in this apparatus, for data transmission in TCP/IP data transmission networks as claimed in the attached claim 12.

According to the present invention, an apparatus and a method are provided for traffic control in TCP/IP data transmission networks, which apparatus and method make it possible to regulate or adapt the transmission speed of data which is transmitted from the first end node to a second end node.

In the following text, the expressions “overload” and “overload situation” should not be understood as meaning an excessively high load level on a network node or on a transmission route, but that the data traffic or packet traffic under consideration exceeds the transmission speed which is defined in a traffic contract.

The adaptation process is carried out by the apparatus for traffic control in that signaling messages which indicate an overload situation are transmitted to the first end node when an overload situation is identified. An overload situation is identified when the data is transmitted from the first end node for a specific time period at a higher transmission speed than the predetermined transmission speed. The predetermined transmission speed is in this case defined, for example, on the basis of a so-called traffic contract.

The transmission speed is in this case obtained either from a packet rate, that is to say a number of data packets within a specific time, or from a data transmission rate, which is obtained, for example, from an average number of transmitted bits within a specific time.

The overload situation is identified by a detection apparatus. When an overload situation is identified, a signaling apparatus produces signaling messages, and transmits them to the first end node.

The advantage of the present invention is that the data rate of the first end node is regulated in a simple manner, without needing to accept packet losses. Furthermore, the reaction time to an overload is considerably faster than with the prior art, where a reaction from the second end node is waited for for overload monitoring.

Advantageous refinements of the present invention are specified in the respective dependent claims.

The apparatus has a physical buffer store, which operates on the FIFO principle (first in, first out), and in which the data packets which are received from the first end node are temporarily stored.

The detection apparatus can use the load level (“filling level”) of this buffer store to detect an overload situation. The detection apparatus identifies overload situations at a specific first threshold (for example 80% above the capacity of the buffer store), and the signaling apparatus produces appropriate signaling messages.

The detection apparatus identifies that the overload situation has ended when, for example, a second threshold, which is lower than the first threshold, is undershot.

The buffer store may also be in the form of a virtual buffer store. In this case, data which is received from the first end node is transmitted to the second end node via the data transmission network without being temporarily stored. All that is stored in the virtual buffer store is values which indicate the data throughput rate. If a specific value (first threshold) is exceeded, then the detection apparatus identifies an overload situation. If a second value (second threshold) is undershot, this is correspondingly identified as being the end of the overload situation.

The overload situation can thus be determined by means of the virtual buffer store, in the same way as in the case of the physical buffer store, on the basis of the first and second thresholds, by the detection apparatus.

A further possible way to determine an overload situation is to identify data or packet losses. If, over a lengthy time period, more data is transmitted from the first end node to the apparatus for traffic control than can be transmitted further from the first transmission apparatus, then data can be rejected (data or packet loss).

When data packets are transmitted in a TCP/IP data transmission network from the first end node to the second end node, then, if the data transmission is successful, the second end node responds to this by transmitting data packets for acknowledgement to the first end node. The signaling apparatus identifies these data packets, which receive an acknowledgement, and, if appropriate, signals the overload situation in these data packets.

It would also be feasible, in the event of an overload situation, for the signaling apparatus to produce special data packets which indicate this overload situation, and to transmit these to the first end node.

In order to signal an overload situation, the signaling apparatus can set a specific bit in the packet header of the IP data packets. The ECN bit (see also the document [2]) in the TOS field (Type of Service) in the IP packet header is suitable in a particularly advantageous manner for this purpose. If this bit is used, the checksum in the TCP packet header need not be recalculated. However, it would also be feasible to use other (previously unused) bits in the IP or TCP packet header.

Furthermore, it would be feasible for the apparatus according to the invention for traffic control to use the reactions to the signaling messages to identify whether the first end node has identified these signaling messages, which indicate an overload indication, as such.

If the first end node does not identify these signaling messages (no reaction to overload situation), then the transmission speed of the first end node is regulated, as before, on the basis of the packet losses. In order to shorten the reaction time in this case, the apparatus for traffic control could, for example, reduce the first threshold; in this case, this threshold is used as a marking, from which data packets are rejected.

The apparatus according to the invention for traffic control is generally located at the interface between the subscriber, which is operating the first end node (host), and the data transmission network. The apparatus is advantageously a component of the first end node.

The present invention will be explained in more detail in the following text using preferred exemplary embodiments and with reference to the attached drawings, in which:

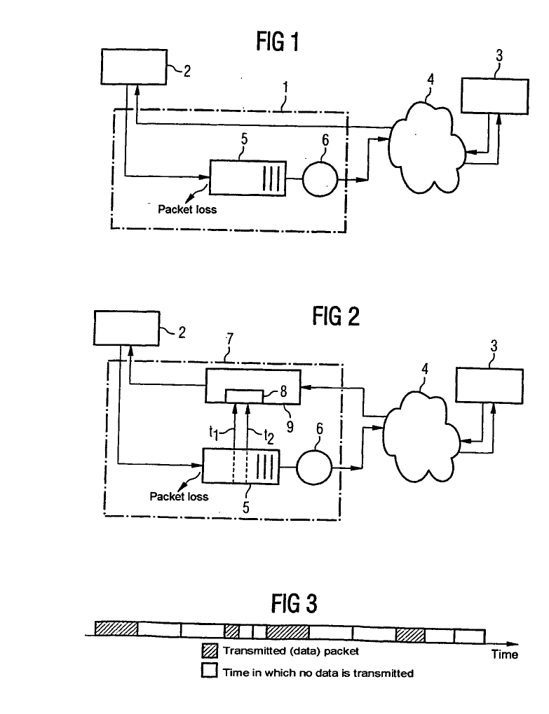

FIG. 1 shows a schematic illustration of the apparatus for traffic control according to the prior art,

FIG. 2 shows a schematic illustration of the apparatus for traffic control according to the present invention, in a TCP/IP data transmission network, and

FIG. 3 shows an illustration of the method of operation for traffic control.

FIG. 1 shows an illustration of an apparatus for traffic control 1 according to the prior art. This apparatus is frequently referred to as a “traffic shaper” in the literature.

When data is transmitted from a first end node 2 (host) via the data transmission network 4 to a second end node 3, then the data traffic in this direction is “formed” by the traffic shaper 1, that is to say it is matched to specific transmission parameters (for example the maximum permissible transmission speed for the data) which are defined, for example, by means of a so-called traffic contract. Data which is transmitted from the first end node 2 is temporarily stored in the buffer store 5 by the traffic shaper 1 until it is transmitted further. The transmission apparatus 6 transmits the temporarily stored data at a predetermined transmission speed via the data transmission network 4 to a second end node 3. The adaptation of the transmission speed will now be explained in more detail with reference to FIG. 3. If the transmission speed through the first end node 2 is too high, then the buffer store is “filled” more quickly than the data is transmitted, until packets are lost. By way of example, this mechanism is known as a “leaky bucket” in ATM transmission technology.

In the prior art, the first end node 2 matches its transmission speed to the available transmission speed by increasing the transmission speed of the data in steps. For each data packet which is received by the second end node 3, this end node 3 transmits a data packet with an acknowledgement, in accordance with the TCP protocol.

If the first end node 2 transmits data at an excessively high transmission speed via the data transmission network, then the buffer store 5 is filled with data until, finally, packets are lost because the capacity of the buffer store 5 is exhausted.

If data packets are lost, then the first end node 2 does not receive an acknowledgement from the second end node 3 for these data packets. This results in the first end node 2 retransmitting the lost data packets, and in this end node 2 then reducing its transmission speed.

This type of adaptation of the transmission speed of the data has the disadvantage that it is relatively slow. No reaction takes place until a specific time has passed, after which no acknowledgement has been received. Furthermore, the loss of data packets must be accepted in this case.

The present invention, as it is illustrated schematically in FIG. 2, provides a remedy for this.

The traffic shaper 1 according to the prior art as shown in FIG. 1 has been extended here to form the traffic shaper 7 according to the invention, which also has a detection apparatus 8 and a signaling apparatus 9.

If the transmission speed at which the first end node 2 transmits data is higher than the preset transmission speed of the transmission apparatus 6 (so-called shaping rate), then the buffer store 5 is filled to an ever greater extent.

In order to avoid packet losses as far as possible, the detection apparatus 8 detects when the buffer store 5 is loaded up to a specific first threshold t₁. If the first threshold t₁ is exceeded, the detection apparatus 8 identifies an overload situation, and signals this to the signaling apparatus 9.

The signaling apparatus 9 sets an appropriate marking in data packets which have been transmitted by the second end node 3 as an acknowledgement for data packets which the second end node 3 has received from the first end node 2, indicating that an overload situation exists; this marking may, for example, be the ECN bit in the TOS field of the IP packet header. In addition, the signaling apparatus 7 transmits the modified data packet to the first end node.

The first end node 2 identifies the set ECN bit, and then reduces the transmission speed by a predetermined amount.

The setting and identification of the first threshold, which is lower than the maximum storage capacity of the buffer store, means that no data packets are lost before the first end node 2 reacts to an overload situation.

In this case, the transmission speed can be reduced either by reducing the bit rate or by reducing the packet rate. Reducing the packet rate results in a reduction in the bit rate over the course of time.

The detection apparatus 8 identifies that the overload situation has ended when the second threshold t₂, which is lower than the first threshold t₁, of the buffer store 5 is undershot.

The signaling apparatus 9 also has the task of classifying data packets which contain an acknowledgement from the second end node. This means that the signaling of an overload situation may be inserted, if required, only for specific applications, while the transmission speed for other applications must not be adversely affected, wherever possible.

If the first end node 2 does not react to the signaling messages which indicate an overload situation, then the data transmission rate is regulated by means of packet losses according to the prior art. If this is identified by the traffic shaper 7 according to the invention, then the first threshold t₁ could be reduced automatically, in order to shorten the reaction time to the overload situation.

The present invention has been described as if there were one buffer store 5 for each end node. It would also be feasible to provide one buffer store for each TCP link (that is to say for different applications); this means that there would be two or more buffer stores for one end node. The ECN bits are inserted in each data packet sent to the first end node, which contains an acknowledgement for this end node. The ECN bits may also be inserted randomly at certain time intervals into the data packets which are used as an acknowledgement for the first end node.

The traffic shaper 7 according to the invention may be integrated in the first end node 2, and may also be in addition to a traffic shaper 1 according to the prior art, which provides access to the data transmission network 4.

The transmission speed at which the transmission apparatus 6 transmits the data via the data transmission network 4 may be set, for example, by means of so-called RSVP signaling (Resource Reservation Protocol).

The method of operation of the transmission apparatus 6 will be explained in more detail in the following text with reference to FIG. 3.

The task of the transmission apparatus 6 is to match the transmission speed at which data is transmitted via the data transmission network to a specific transmission speed which is defined in advance. This preset transmission speed is defined, for example, by a so-called traffic contract.

In the example shown in FIG. 3, one third of the maximum transmission capacity of the transmission path (link) is available as maximum transmission speed to the first end node. The transmission apparatus accordingly transmits a data packet, and inserts a transmission pause before the next data packet. In the example, the transmission pause in this case lasts for twice as long as the time required to transmit the last data packet.

1. An apparatus for traffic control (7) in TCP/IP data transmission networks for matching the transmission speed at which data is transmitted from a first end node (2) via a transmission network (4) to a second end node (3) to a predetermined transmission speed, having
a transmission apparatus (6) which transmits the data which is received from the first end node (2) via the data transmission network (4) to the second end node (3) at most at the predetermined transmission speed,
characterized by
a detection apparatus (8) for identifying an overload situation, in which the data is transmitted from the first end node (2) over a specific period of time at a higher transmission speed than the predetermined transmission speed, and
a signaling apparatus (9) which produces appropriate signaling messages when an overload situation occurs and transmits these signaling messages to the first end node (2).

2. The apparatus (7) as claimed in claim 1,
characterized by
a physical buffer store (5), which temporarily stores the data which is received from the first end node (2) until it is transmitted further.

3. The apparatus (7) as claimed in claim 1,
characterized by
a virtual buffer store, which temporarily stores values which indicate the current data throughput rate.

4. The apparatus (7) as claimed in claim 1, 2 or 3,
characterized
in that the detection apparatus (8) identifies the overload situation on the basis of a specific first threshold t₁ being exceeded with respect to the amount of data which is stored in the physical buffer store (5), or with respect to the value which is stored in the virtual buffer store.

5. The apparatus (7) as claimed in claim 4,
characterized
in that the detection apparatus (8) identifies the undershooting of a second threshold t₂, which is lower than the first threshold t₁, as the end of the overload situation.

6. The apparatus (7) as claimed in one of claims 1 to 5,
characterized
in that the detection apparatus (8) identifies the overload situation on the basis of data losses.

7. The apparatus (7) as claimed in one of claims 1 to 6,
characterized
in that the signaling apparatus (9) inserts the signaling messages into data packets which are transmitted from the second end node (3) to the first end node (2), with these data packets including acknowledgement of the data which is received from the first end node (2).

8. The apparatus (7) as claimed in one of claims 1 to 7,
characterized
in that the signaling apparatus (9) transmits the signaling messages to the first end node (2) in specially produced data packets.

9. The apparatus (7) as claimed in claim 7 or 8,
characterized
in that the signaling apparatus (9) signals an overload by means of a specific set bit in the packet header of the data packets.

10. The apparatus (7) as claimed in one of claims 1 to 9,
characterized
in that the apparatus (7) identifies whether the first end node (2) can process the signaling messages, and sets the threshold t₁ as a function of this.

11. The apparatus (7) as claimed in one of claims 1 to 10,
characterized
in that the apparatus (7) is a component of the first end node (2).

12. A method for traffic control (7) in TCP/IP data transmission networks for matching the transmission speed at which data is transmitted from a first end node (2) via a transmission network (4) to a second end node (3) to a predetermined transmission speed, with the data which is received from the first end node (2) being transmitted via the data transmission network (4) to the second end node (3) at most at the predetermined transmission speed,
characterized by the following steps:
identification of an overload situation, in which the data is transmitted from the first end node (2) over a specific period of time at a higher transmission speed than the predetermined transmission speed, and
production of appropriate signaling messages when an overload situation occurs and transmission of the signaling messages to the first end node (2).

13. The method as claimed in claim 12,
characterized
in that the data which is received from the first end node (2) is temporarily stored until it is transmitted further.

14. The method as claimed in claim 12,
characterized
in that values are temporarily stored which indicate the current data throughput rate.

15. The method as claimed in claim 12, 13 or 14,
characterized
in that the overload situation is identified on the basis of a specific first threshold t₁ being exceeded with respect to the buffer-stored amount of data or with respect to the buffer-stored value.

16. The method as claimed in claim 15,
characterized
in that the undershooting of a second threshold t₂, which is lower than the first threshold t₁, is identified as the end of the overload situation.

17. The method as claimed in one of claims 12 to 16,
characterized
in that the overload situation is identified on the basis of data losses.

18. The method as claimed in one of claims 12 to 17,
characterized
in that the signaling messages are inserted into data packets which are transmitted from the second end node (3) to the first end node (2), with these data packets including acknowledgement of the data which is received from the first end node (2).

19. The method as claimed in one of claims 12 to 18,
characterized
in that the signaling messages are transmitted to the first end node (2) in specially produced data packets.

20. The method as claimed in claim 18 or 19,
characterized
in that an overload is signaled by means of a specific set bit in the packet header of the data packets.

21. The method as claimed in one of claims 12 to 20,
characterized
in that the method identifies whether the first end node (2) can process the signaling messages, and sets the threshold t₁ as a function of this.

22. The method as claimed in one of claims 12 to 22,
characterized
in that the method is used in the first end node (2).
